(19) United States
(12) Patent Application Publication
(10) Pub. No.: US 2006/0185404 A1
(43) Pub. Date: Aug. 24, 2006

(54) Codeable padlock

(76) Inventor: Randall C. Hansen, Lexington, SC (US)

Correspondence Address: MCNAIR LAW FIRM, P.A., P.O. BOX 10827, GREENVILLE, SC, 29603-0827, US

(21) Appl. No.: 11/356,669

(22) Filed: Feb. 17, 2006

Related U.S. Application Data
(60) Provisional application No. 60/654,117, filed on Feb. 18, 2005.

(51) Int. Cl. E05B 67/24

(52) U.S. Cl. 70/38 A

(57) ABSTRACT

A padlock housing and a shackle protruding from the housing having a secured position releasably secured in the housing, and an unsecured position wherein at least a portion of the shackle is removable from the housing. A shackle retainer control having a locked position engaging the shackle to prevent movement of the shackle between the secured and unsecured positions, and an unlocked position disengaged from the shackle allowing movement of the shackle between the secured and unsecured positions. A codeable actuator operatively connected with the shackle retainer control for controlling movement of the shackle retainer control between the locked position and the unlocked position. The codeable actuator adapted for receiving a pre-existing key and being coded to the pre-existing key, wherein the pre-existing key is operable to manipulate the codeable actuator once coded to the actuator to lock and unlock the shackle retainer control.

### CROSS REFERENCE TO RELATED APPLICATION

This application claims priority from a provisional application filed Feb. 18, 2005, under Ser. No. 60/654,117.

### FIELD OF THE INVENTION

The present invention relates generally to padlocks, and more particularly, to a padlock housing adapted for receiving a codeable lock cylinder allowing a user to code a pre-existing key to the lock cylinder to operate the padlock.

### BACKGROUND OF THE INVENTION

In securing valuables, it is common to use a padlock for such things as connecting chains, locking doors, securing latches, and other devices. Generally, there are two basic types of padlocks consisting of combination locks and key actuated locks. Most combination locks utilize a single manually operated dial with a series of numbers which is rotated in a certain sequence to open the lock. Alternatively a series of dials or wheels can be used to align a specific number or letter combination to open the padlock. In the second major class of padlock, a key is used to engage a locking cylinder to actuate the locking mechanism to open the padlock. Padlocks requiring a combination to remember are problematic as the combination may be forgotten if not regularly used, or the combination may be written down and becomes lost, making the lock useless. Keyed padlocks are typically sold with a set of two keys designed specifically for actuating the lock cylinder of the designated padlock. The keys are machines to match required characteristics of the lock cylinder in the associated padlock. This requires the user of the padlock to keep up with a set of keys for each specific padlock. Again, if the key is lost, then the padlock becomes useless.

While lock cylinders codeable to pre-existing keys are known in the prior art, it is not known in the prior art to incorporate such codeable lock cylinders into traditional padlock housing designs.

Accordingly, it would be advantageous for a padlock to have a lock cylinder that may be coded to a pre-existing key, allowing the user to have a single key to operate one or more padlocks, as well as the other equipment for which the key was originally intended, such as a vehicle or door lock. This allows for a reduction in the number of keys that must be maintained by the user as well as the additional convenience of having a frequently used key for unlocking one or more padlocks.

Therefore, it is an object of the present invention to provide a padlock housing adapted to receive a lock cylinder codeable to a pre-existing key.

### SUMMARY OF THE INVENTION

The above objective is accomplished according to the present invention by providing a padlock housing and a shackle protruding from the housing having a secured position wherein the shackle is releasably secured in the housing, and an unsecured position wherein at least a portion of the shackle is removed from the housing for attaching and removing the shackle from an item to be secured. A shackle retainer control included in the housing having a locked position engaging the shackle to prevent movement of the shackle between the secured and unsecured positions, and an unlocked position disengaged from the shackle allowing movement of the shackle between the secured and unsecured positions. A codeable actuator operatively connected with the shackle retainer control for controlling movement of the shackle retainer control between the locked position and the unlocked position. The codeable actuator adapted for receiving a pre-existing key and being coded to the pre-existing key when the pre-existing key is inserted into the codeable actuator, wherein the pre-existing key is operable to manipulate the codeable actuator once coded to the codeable actuator to lock and unlock the shackle retainer control.

In a preferred embodiment, the codeable actuator comprises a lock cylinder carried in an actuator cavity in the housing in mechanical connection with the shackle retainer control.

In a further advantageous embodiment, the actuator cavity includes at least one guide member protruding from a wall of the actuator cavity, and the lock cylinder includes a surface recess complementary to the guide member receiving the guide member to prevent rotation of the cylinder in the housing.

In a preferred embodiment, at least one cylinder retaining member is carried by the padlock housing engaging the lock cylinder to prevent removal of the cylinder from the housing. Preferably, the at least one cylinder retaining member includes a first retractable pawl biased to protrude into the actuator cavity, and a second retractable pawl biased to protrude into the actuator cavity. The first and second retractable pawls are adapted to retract when the lock cylinder is being inserted into the actuator cavity, and extend to engage cooperating pawl receiving slots in the cylinder once inserted into the actuator cavity so that the cylinder cannot be removed from the housing.

In a further advantageous embodiment, the shackle retainer control includes a cam rotatably carried in the housing for engaging the shackle when the shackle retainer control is in the locked position to maintain the shackle in the secured position, and disengaging from the shackle when the shackle retainer control is in the unlocked position to allow movement of the shackle to the unsecured position. In this embodiment, it is preferred that the codeable actuator includes a rotatable shaft key engaging a keyway in the cam for rotating the cam to engage and disengage the shackle, wherein the shaft key is rotated when the pre-existing key coded to the codeable actuator is received in the codeable actuator and rotated.

In a further advantageous embodiment, the shackle retainer control includes a ball lock bearing for engaging a lock detent in the shackle, and a cam for biasing the bearing into the lock detent when the shackle is in the secure position and the shackle retainer control is in the locked position, wherein the cam includes a release detent for withdrawing the bearing from the lock detent when the shackle retainer control is in the unlocked position. In this embodiment, the codeable actuator includes a rotatable shaft key engaging a keyway in the cam for rotating the cam to engage and disengage the ball lock bearing from the lock detent, wherein the shaft key is rotated when the pre-existing key coded to the codeable actuator is received in the codeable actuator and rotated.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a perspective view illustrating the lock housing according to the present invention;

FIG. 2 shows a bottom plan view of the padlock housing without a codeable lock cylinder therein according to the present invention;

FIG. 3a shows a cutaway side elevation view of a codeable lock cylinder partially inserted into the padlock housing according to the present invention;

FIG. 3b shows a cutaway side elevation view of the codeable lock cylinder fully inserted into the padlock housing with the shackle in a secured position according to the present invention;

FIG. 3c shows a cutaway side elevation view of the codeable lock cylinder fully inserted into the padlock housing with the shackle in an unsecured position according to the present invention;

FIG. 4a shows a cutaway side elevation view of an alternative embodiment of the codeable lock cylinder received in the padlock housing with the shackle in a secure position according to the present invention;

FIG. 4b shows a cutaway side elevation view of an alternative embodiment of the codeable lock cylinder received in the padlock housing with the shackle in an unsecured position according to the present invention;

FIG. 5 shows a side elevation view of the codeable lock cylinder according to the present invention; and

FIG. 6 shows a perspective view of the padlock housing and codeable lock cylinder as assembled according to the present invention.

### DESCRIPTION OF A PREFERRED EMBODIMENT

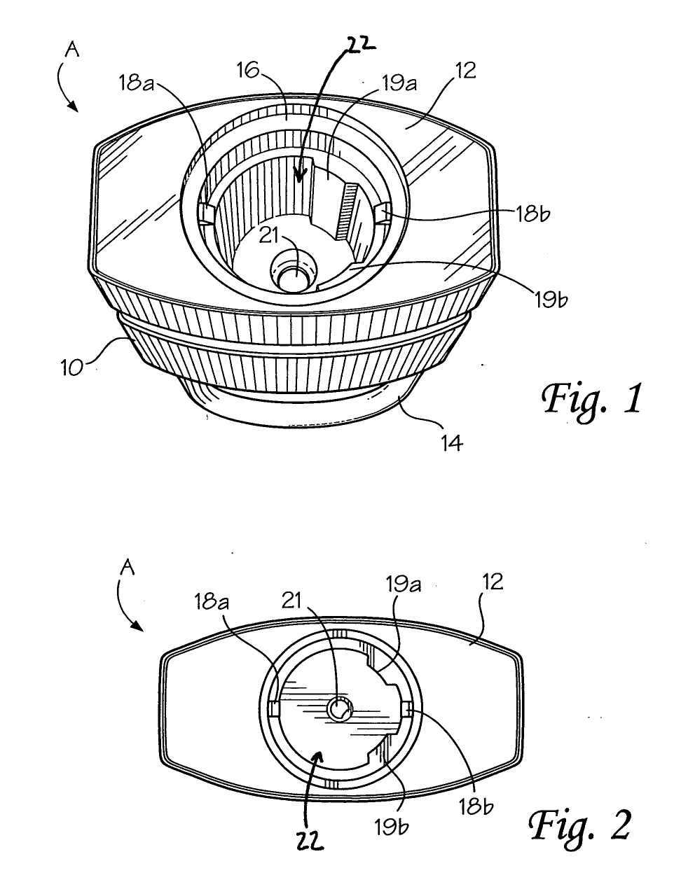

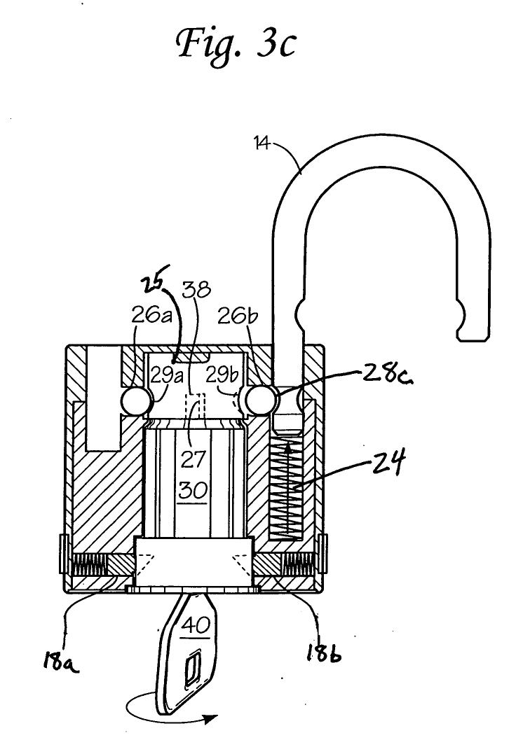

With reference to the drawings, the invention will now be described in more detail. Referring to FIGS. 1 and 3a, a codeable padlock, designated generally as A, is shown. The codeable padlock includes a padlock housing 10 having a bottom face 12 and a top face 13. A shackle 14 is carried by padlock housing 10 and protrudes from opening in top face 13 of padlock housing 10. Bottom face 12 opens into an actuator cavity, designated generally as 22, adapted for receiving a codeable actuator 30, thus creating a codeable padlock.

Referring to FIGS. 3a and 3c, shackle 14 has a secured position releasably secured in padlock housing 10, as illustrated in FIG. 3a, and an unsecured position, shown in FIG. 3c, wherein at least a portion of the shackle is removed from the housing for attaching and removing the shackle from an item to be secured. Referring to FIGS. 3b and 3c, shackle 14 is spring-biased via spring 24 to move between said secured and unsecured positions when released as detailed herein below.

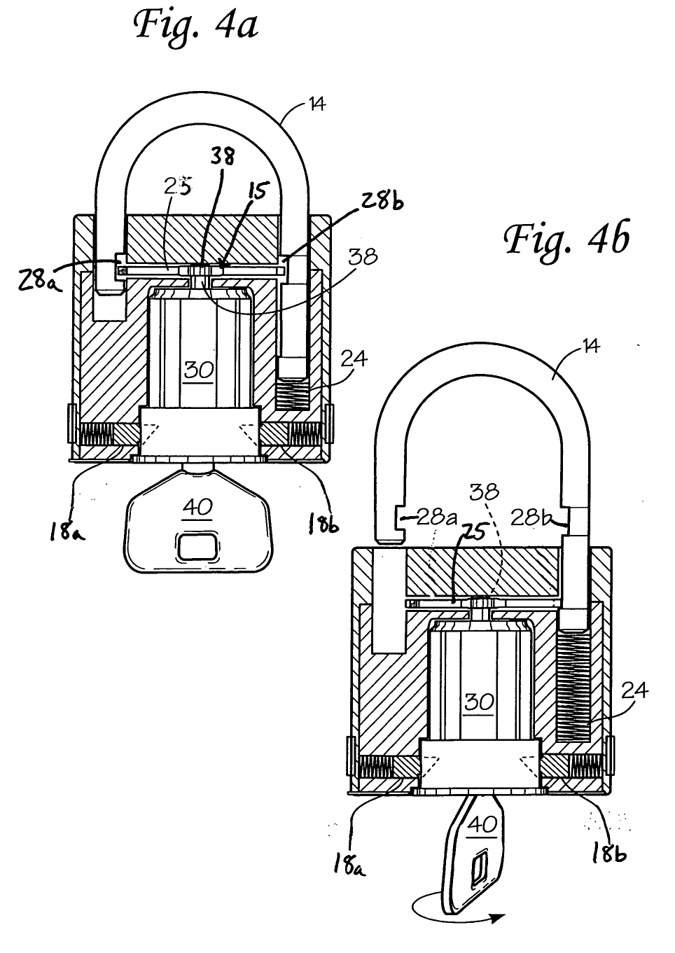

A shackle retainer control, designated generally as 15, is included in padlock housing 10 adjacent actuator cavity 22 having a locked position, as shown in FIGS. 3a, 3b and 4a, engaging the shackle to prevent movement of the shackle between the secured and unsecured positions of the shackle. Shackle retainer control 15 is also operable to move to an unlocked position, shown in FIGS. 3c and 4b, disengaged from the shackle allowing movement of the shackle between the secured and unsecured positions to attach or remove the padlock from an item.

Referring to FIGS. 3c and 4b, codeable actuator 30 is operatively connected with shackle retainer control 15 when received in actuator cavity 22, as described herein below in further detail, for controlling movement of shackle retainer control 15 between the locked position and the unlocked position. Codeable actuator 30 is adapted for receiving a pre-existing key 40 and being coded to pre-existing key 40 when the pre-existing key is inserted into codeable actuator 30, wherein pre-existing key 40 is operable to manipulate codeable actuator 30 once coded to codeable actuator 30 to lock and unlock the shackle retainer control by rotating in codeable actuator 30.

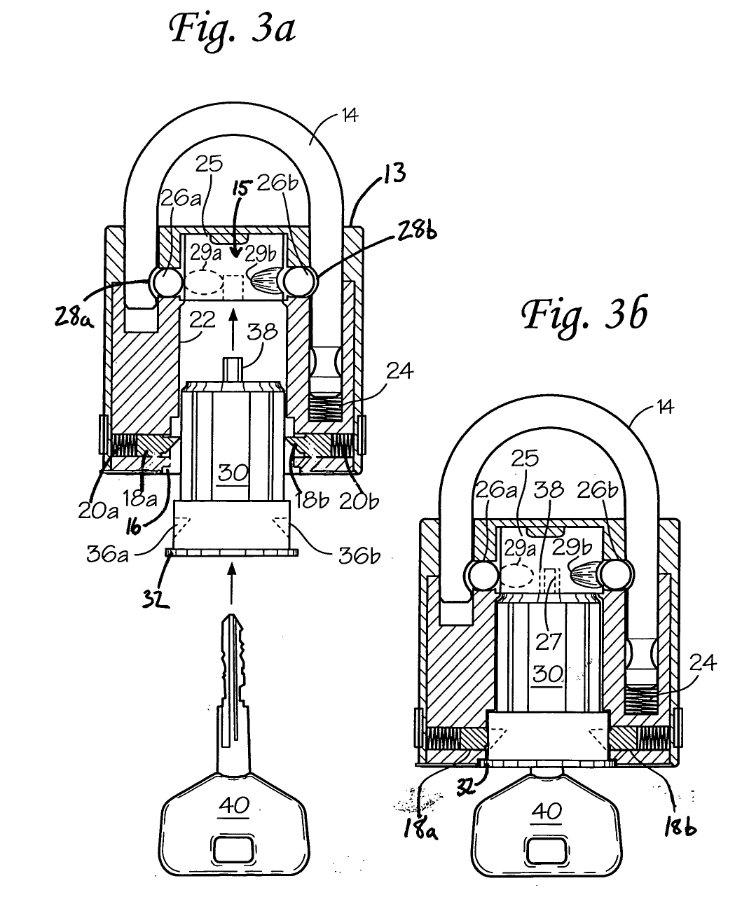

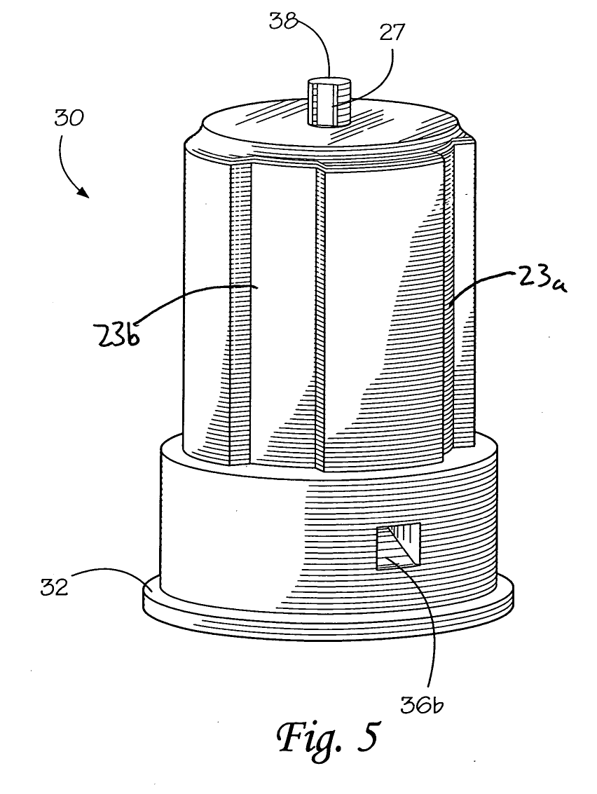

Referring to FIG. 5, in a preferred embodiment, codeable actuator 30 comprises a lock cylinder, also identified by reference number 30 herein, for being carried in actuator cavity 22 in padlock housing 10 in mechanical connection with shackle retainer control 15. Further referring to FIGS. 1 and 2, actuator cavity 22 contains a flange recess 16 for engaging flange 32 of lock cylinder 30, designed to support codeable lock cylinder 30 in actuator cavity 22. As shown in FIGS. 3a and 3b, flange 32 of codeable lock cylinder 30 is received in flange recess 16 when the lock cylinder is received by housing 10.

Referring to FIGS. 1 and 2, actuator cavity 22 has an interior surface arranged in a complementary shape to the exterior of lock cylinder 30 that is designed to receive and retain codeable lock cylinder 30 in housing 10. Included within the interior surface of actuator cavity 20 are guide members 19a and 19b protruding from the interior surface wall of the actuator cavity. Referring to FIG. 5, lock cylinder 30 includes surface recesses 23a and 23b shaped in a complementary form to guide members 19a and 19b to receive the guide member to prevent rotation of the cylinder in the housing. Additional guide members or protrusions may be added to the interior surface of actuator cavity 22 for additional interconnection between lock cylinder 30 and actuator cavity 22.

In a preferred embodiment, at least one cylinder retaining member is carried by padlock housing 10 for engaging lock cylinder 30 to prevent removal of the cylinder from housing 10 once inserted. Referring to FIGS. 1 and 2, in the illustrated embodiment, the at least one cylinder retaining member includes a first retractable pawl 18a biased to protrude into actuator cavity 22, and a second retractable pawl 18b biased to protrude into actuator cavity 22. Referring to FIG. 3a, the first and second retractable pawls 18a and 18b are adapted to retract when lock cylinder 30 is being inserted into actuator cavity 22, and extend to engage cooperating pawl receiving slots 36a and 36b in lock cylinder 30 once inserted into actuator cavity 22 so that the cylinder cannot be removed from the housing. The retractable pawls 18a and 18b are spring-biased by springs 20a and 20b to protrude into actuator cavity 22. This allows retractable pawls 18a and 18b to be retracted upon the insertion of codeable lock cylinder 30 as shown in FIG. 3a. Once lock cylinder 30 has been inserted into actuator cavity 22, retractable pawls 18a and 18b extend into opening 36a and 36b, respectively, of lock cylinder 30 to maintain the lock cylinder in place. Retractable paws 18a and 18b contain slanted contact faces for receiving lock cylinder 30. The slanted contact face facilitates sliding engagement between lock cylinder 30 and retractable pawls 18a and 18b to push the pawls into housing 10 when lock cylinder 30 is inserted. The lock cylinder contacts the faces during insertion and applies pressure to the retractable pawls pushing them against their respective springs 20a and 20b. This allows the lock cylinder to enter padlock housing 10 and become operatively associated shackle retainer control 15, while preventing removal of lock cylinder 30 from housing 10 once pawls 18a and 18b are received in pawl receiving slots 36a and 36b of lock cylinder 30.

Referring to FIGS. 1 and 2, actuator cavity 22 extends into the lock housing towards top face 13. The upper portion of actuator cavity 22 contains a keyway 21 for allowing lock cylinder 30 to be engaged via rotatable shaft key 38 (FIG. 5) into shackle retainer control 15 to operate control 15 between the locked and unlocked positions to retainer or release shackle 14. As shown in FIG. 5, rotatable shaft key 38 includes a keyed side 27 for corresponding to the shape of keyway 21 to cooperate with the keyway in a rotatable arrangement as detailed herein below.

Referring to FIGS. 4a and 4b, in one embodiment, shackle retainer control 15 includes a cam 25 in the form of a plate rotatably carried in housing 10 for engaging shackle 14 when shackle retainer control 15 is in the locked position to maintain the shackle in the secured position, as shown in FIG. 4a. In the locked position, cam 25 extends into shackle detents 28a and 28b to secure shackle 14 in housing 10. As shown in FIG. 4b, cam 25 is constructed and arranged so that rotation of cam 25 when shackle retainer control 15 is moved to the unlocked position disengages cam 25 from shackle detents 28a and 28b of shackle 14 to allow movement of shackle 14 to the unsecured position. In this embodiment, it is preferred that codeable lock cylinder 30 include rotatable shaft key 38 engaging keyway 21 which is disposed in cam 25 for rotating the cam to engage and disengage shackle 14. Shaft key 38 is rotated when pre-existing key 40 is coded to lock cylinder 30 and is received in the lock cylinder and rotated.

Referring to FIGS. 3a-3c, in an alternative embodiment, rather than using a plate shaped cam for engaging shackle 14, ball lock bearings 26a and 26b are provided for engaging shackle detents 28a and 28b. Accordingly, shackle retainer control 15 includes ball lock bearing 26a and 26b for engaging lock detent 28a and 28b in shackle 14. In this arrangement, cam 25 is provided in the form of a rotatable cylinder for biasing bearing 26a and 26b into their respective lock detents 28a and 28b when shackle 14 is in the secure position in housing 10 and shackle retainer control 15 is in the locked position, as shown in FIGS. 3a and 3b. Cam 25 includes release detents 29a and 29b operatively associated with bearings 26a and 26b for withdrawing the bearings from lock detent 28a and 28b when shackle retainer control 15 is moved to the unlocked position by rotating cam 25 to align release detents 29a and 29b with bearings 26a and 26b. Release detent 29b of cam 25 is constructed and arranged to first withdraw bearing 26b from lock detent 28b when cam 25 is rotated but then biases bearing 26b back against shackle 14 into shackle retaining detent 28c to prevent complete removal of shackle 14 from housing 10, as shown in FIG. 3c. Also in this embodiment, codeable lock cylinder 30 includes rotatable shaft key 38 engaging keyway 21 disposed in cam 21 for rotating cam 25 to engage and disengage ball lock bearing 26a and 26b from lock detent 28a and 28b. Shaft key 38 is rotated when pre-existing key 40 is coded to lock cylinder 30 and is received in the lock cylinder and rotated.

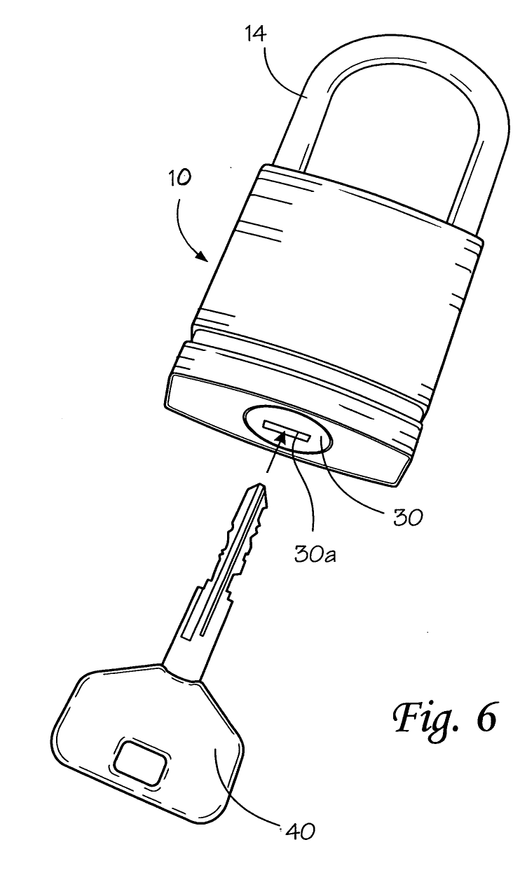

Referring now to FIG. 6, pre-existing key 40 is shown for insertion into codeable lock cylinder 30 of padlock housing 10. Pre-existing key 40 is, for example, an automobile key with no relation to codeable lock cylinder 30. Lock cylinder 30 controls shackle 14 by engaging shackle retainer control 15 as detailed above. By placing pre-existing key 40 into keyway 30a of lock cylinder 30 and turning the key, shackle 14 is released and opened, allowing for attachment or removal of the padlock to an item. This is accomplished after codeable lock cylinder 30 has been coded to pre-existing key 40, which requires first placing key 40 into keyway 30a for the first time to perform the coding procedure. Codeable lock cylinder 30 is not coded to any key until a key is first inserted into keyway 30a. Once key 40 is placed into keyway 30a for the first time and turned in lock cylinder 30, then lock cylinder 30 is coded to fit only key 40, and no other keys. Further, once coded initially, lock cylinder 30 cannot be recoded to fit any other key.

The codeable lock cylinder 30 described above functions in a similar manner as those manufactured by Strattec Corporation or in any other feasible means by which an assembled lock cylinder can be coded by any type of key upon first usage. The codeable lock cylinders can also operate as disclosed in United States Patent Application Publication number 2003/0154753 which is incorporated herein in its entirely by reference. Note that codeable lock cylinder 30 may also function as disclosed in U.S. Pat. No. 4,966,021 which is also incorporated herein by reference in its entirely.

Pre-existing key 40 may generally be any type of key, and after first insertion into codeable lock cylinder 30, it is coded to lock cylinder. In a preferred embodiment, key 40 is an automobile key that can be used to code the padlock. By way of example, the user of this system could be an individual that enjoys outdoor activities such as boating. This person could have multiple padlocks used when traveling with a boat to a lake. These padlocks can include padlocks on the trailer to ensure a secure attachment of the trailer and the boat and the vehicle. Other padlocks could be found on coolers in the boat, the boat cover, and throughout the boat and trailer area. The driver of the vehicle would simply use key 40 which would be the key to the vehicle to code each of these padlocks. Thus, the driver of the vehicle could be able to unlock each of the padlocks associated with the boat and trailer, with just one key. Further, that one key would be the key they use to operate the vehicle towing the boat. Therefore, no additional keys would be necessary as the key that unlocks all of the padlocks would be the same key used to operate the vehicle.

While a preferred embodiment of the invention has been described using specific terms, such description is for illustrative purposes only, and it is to be understood that changes and variations may be made without departing from the spirit or scope of the following claims.

What is claimed is:

1. A padlock codeable to a pre-existing key, comprising:
a padlock housing;
a shackle protruding from said housing having a secured position wherein said shackle is releasably secured in said housing, and an unsecured position wherein at least a portion of said shackle is removed from said housing for attaching and removing said shackle from an item to be secured;
a shackle retainer control having a locked position engaging said shackle to prevent movement of said shackle between said secured and unsecured positions, and an unlocked position disengaged from said shackle allowing movement of said shackle between said secured and unsecured positions;
a codeable actuator operatively connected with said shackle retainer control for controlling movement of said shackle retainer control between said locked position and said unlocked position; and,
said codeable actuator adapted for receiving a pre-existing key and being coded to said pre-existing key when said pre-existing key is inserted into said codeable actuator, wherein said pre-existing key is operable to manipulate said codeable actuator once coded to said codeable actuator to lock and unlock said shackle retainer control.

2. The padlock of claim 1 wherein said codeable actuator comprises a lock cylinder carried in an actuator cavity in said housing in mechanical connection with said shackle retainer control; and, wherein said actuator cavity includes at least one guide member protruding from a wall of said actuator cavity, and said lock cylinder including a surface recess complementary to said guide member receiving said guide member to prevent rotation of said cylinder in said housing.

3. The padlock of claim 2 including at least one cylinder retaining member carried by said padlock housing engaging said lock cylinder to prevent removal of said cylinder from said housing.

4. The padlock of claim 3 wherein said at least one cylinder retaining member includes a first retractable pawl biased to protrude into said actuator cavity, and a second retractable pawl biased to protrude into said actuator cavity; wherein said first and second retractable pawls are adapted to retract when said lock cylinder is being inserted into said actuator cavity, and extend to engage cooperating pawl receiving slots in said cylinder once inserted into said actuator cavity so that said cylinder cannot be removed from said housing.

5. The padlock of claim 1 wherein said shackle retainer control includes a cam rotatably carried in said housing for engaging said shackle when said shackle retainer control is in said locked position to maintain said shackle in said secured position, and disengaging from said shackle when said shackle retainer control is in said unlocked position to allow movement of said shackle to said unsecured position.

6. The padlock of claim 5 wherein said codeable actuator includes a rotatable shaft key engaging a keyway in said cam for rotating said cam to engage and disengage said shackle; and, wherein said shaft key is rotated when said pre-existing key coded to said codeable actuator is received in said codeable actuator and rotated.

7. The padlock of claim 1 wherein said shackle retainer control includes a ball lock bearing for engaging a lock detent in said shackle, and a cam for biasing said bearing into said lock detent when said shackle is in said secure position and said shackle retainer control is in said locked position; and, wherein said cam includes a release detent for withdrawing said bearing from said lock detent when said shackle retainer control is in said unlocked position.

8. The padlock of claim 7 wherein said codeable actuator includes a rotatable shaft key engaging a keyway in said cam for rotating said cam to engage and disengage said ball lock bearing from said lock detent; and, wherein said shaft key is rotated when said pre-existing key coded to said codeable actuator is received in said codeable actuator and rotated.

9. A padlock for receiving a lock cylinder codeable to a pre-existing key, said padlock comprising:
a padlock housing;
a shackle protruding from said housing having a secured position wherein said shackle is releasably secured in said housing, and an unsecured position wherein at least a portion of said shackle is removed from said housing for attaching and removing said shackle from an item to be secured;
a shackle retainer control having a locked position engaging said shackle to prevent movement of said shackle between said secured and unsecured positions, and an unlocked position disengaged from said shackle allowing movement of said shackle between said secured and unsecured positions;
an actuator cavity included in said housing for receiving a lock cylinder codeable to a pre-existing key upon insertion of said pre-existing key into said lock cylinder, and said lock cylinder adapted to manipulate said shackle retainer control between said locked and unlocked positions once inserted into said actuator cavity;
at least one guide member protruding from a wall of said actuator cavity for engaging a complementary surface recess in said lock cylinder to prevent rotation of said cylinder when inserted into said housing; and,
at least one cylinder retaining member carried by said padlock housing for engaging said lock cylinder to prevent removal of said cylinder from said housing.

10. The padlock of claim 9 wherein said at least one cylinder retaining member includes a first retractable pawl biased to protrude into said actuator cavity, and a second retractable pawl biased to protrude into said actuator cavity; wherein said first and second retractable pawls are adapted to retract when said lock cylinder is being inserted into said actuator cavity, and extend to engage cooperating pawl receiving slots in said cylinder once inserted into said actuator cavity so that said cylinder cannot be removed from said housing.

11. The padlock of claim 1 wherein said shackle retainer control includes a cam rotatably carried in said housing for engaging said shackle when said shackle retainer control is in said locked position to maintain said shackle in said secured position, and disengaging from said shackle when said shackle retainer control is in said unlocked position to allow movement of said shackle to said unsecured position.

12. The padlock of claim 11 wherein said cam includes a keyway open to said actuator cavity for receiving a rotatable shaft key carried by said lock cylinder for rotating said cam to engage and disengage said shackle.

13. The padlock of claim 9 wherein said shackle retainer control includes a ball lock bearing for engaging a lock detent in said shackle, and a cam for biasing said bearing into said lock detent when said shackle is in said secure position and said shackle retainer control is in said locked position; and, wherein said cam includes a release detent for withdrawing said bearing from said lock detent when said shackle retainer control is in said unlocked position.

14. The padlock of claim 13 wherein said cam includes a keyway open to said actuator cavity for receiving a rotatable shaft key carried by said lock cylinder for rotating said cam to engage and disengage said ball lock bearing from said shackle.

15. A padlock codeable to a pre-existing key, comprising:
a padlock housing carrying a shackle;
a shackle retainer control for securing and releasing said shackle in said housing;
an actuator cavity disposed in said housing in communication with said shackle retainer control; and,
a codeable lock cylinder carried in said actuator cavity being coded to a pre-existing key by insertion of said pre-existing key into said lock cylinder;
wherein said lock cylinder is operatively connected to said shackle retainer control for moving said shackle retainer control between a locked position securing said shackle in said housing and an unlocked position releasing said shackle when said pre-existing key coded to said lock cylinder is inserted into said lock cylinder and rotated to cause actuation of said shackle retainer control.

16. The padlock of claim 15 wherein said actuator cavity includes at least one guide member protruding from a wall of said actuator cavity, and said codeable lock cylinder including a surface recess complementary to said guide member receiving said guide member to prevent rotation of said cylinder in said housing.

17. The padlock of claim 16 including at least one cylinder retaining member carried by said padlock housing engaging said codeable lock cylinder to prevent removal of said cylinder from said housing.

18. The padlock of claim 17 wherein said at least one cylinder retaining member includes a first retractable pawl biased to protrude into said actuator cavity, and a second retractable pawl biased to protrude into said actuator cavity; wherein said first and second retractable pawls are adapted to retract when said lock cylinder is being inserted into said actuator cavity, and extend to engage cooperating pawl receiving slots in said codeable lock cylinder once inserted into said actuator cavity so that said lock cylinder cannot be removed from said housing.

19. The padlock of claim 15 wherein said shackle retainer control includes a cam rotatably carried in said housing for engaging said shackle when said shackle retainer control is in said locked to retain said shackle in said housing, and disengaging from said shackle when said shackle retainer control is in said unlocked position to release said shackle.

20. The padlock of claim 19 wherein said codeable lock cylinder includes a rotatable shaft key engaging a keyway in said cam for rotating said cam to engage and disengage said shackle; and, wherein said shaft key is rotated when said pre-existing key coded to said codeable lock cylinder is received in said codeable lock cylinder and rotated.

21. The padlock of claim 15 wherein said shackle retainer control includes a ball lock bearing for engaging a lock detent in said shackle, and a cam for biasing said bearing into said lock detent when said shackle retainer control is in said locked position; and, wherein said cam includes a release detent for withdrawing said bearing from said lock detent when said shackle retainer control is in said unlocked position.

22. The padlock of claim 21 wherein said codeable lock cylinder includes a rotatable shaft key engaging a keyway in said cam for rotating said cam to engage and disengage said ball lock bearing from said lock detent; and, wherein said shaft key is rotated when said pre-existing key coded to said codeable lock cylinder is received in said codeable lock cylinder and rotated.
